(19) United States
(12) Patent Application Publication
(10) Pub. No.: US 2008/0068132 A1
(43) Pub. Date: Mar. 20, 2008

(54) Contactless radiofrequency device featuring several antennas and related antenna selection circuit

(76) Inventors: Georges Kayanakis, Antibes (FR); Yannick Grasset, Vallauris (FR); Elias Sabbah, Valbonne (FR)

Correspondence Address: JAMES C. LYDON, 100 DAINGERFIELD ROAD, SUITE 100, ALEXANDRIA, VA, 22314, US

(21) Appl. No.: 11/798,456

(22) Filed: May 14, 2007

(30) Foreign Application Priority Data
May 16, 2006 (FR) 0604363
May 16, 2006 (FR) 0604365

(51) Int. Cl. H04Q 5/22

(52) U.S. Cl. 340/10.1

(57) ABSTRACT

The invention relates to an integrated circuit for contactless radiofrequency device connected to a first antenna and to a second antenna designed to receive a radiofrequency signal coming from a reader. According to a main characteristic, the integrated circuit includes a first rectifier circuit and a second rectifier circuit to rectify each radiofrequency signal received from the first antenna and the second antenna, respectively, so as to produce two positive output voltages V1 and V2, the rectifier circuits being mounted in parallel in order to select an output voltage value that corresponds to the maximum voltage value between V1 and V2.

### TECHNICAL FIELD

This invention concerns radiofrequency devices (RFID) and specifically concerns contactless radiofrequency devices featuring several antennas and their associated antenna selection circuit.

### BACKGROUND ART

At present, contactless transceiver devices are widely used in numerous applications. One of these applications is the contactless smart card, which is being increasingly used in various sectors, such as the public transport sector, for example. They have also been developed as a means of payment.

The exchange of information between a contactless device and the associated reader is accomplished by remote transmission of electromagnetic signals between an antenna housed in the contactless device and a second antenna located in the reader. In order to gather, store and process information, the device is equipped with a microcircuit connected to the antenna and featuring a memory zone. During the exchange of information, power to the contactless device is supplied by electromagnetic waves transmitted by the reader.

An application of these contactless devices that is gaining more and more importance is their use as labels affixed on objects for their identification in tracking goods or the inventory position. In these applications, the microcircuit of the label affixed on each object contains in memory the data of the object which allows the object to be indexed and identified and thereby ensure its traceability.

The label is affixed on the object at the time of its creation and accompanies it until it is received by the client. The memory of the microcircuit contains information concerning the characteristics of the object or its contents in the case of a container. This information can be read at all times by a reader. Currently, the frequencies commonly used by the reader for the exchange of data with the label are ultra high frequencies (UHF) from 860 MHz to 960 MHz which allow the label to be read from a distance of more than 2 meters.

A simple antenna that can be used in contactless labels known as RFID labels 100 such as those represented in FIG. 1 is the dipole antenna 112 that has the dimension of approximately a half-wave length for the operating frequency. The special feature of such a dipole resides in the fact that the energy is radiated mainly in a preferred direction perpendicular to the axis of the dipole. As a result, a simple dipole used as an antenna has a major drawback of having directional radiation, which means that the label is not functional in all directions but only along certain special directions.

One solution to offset this drawback is to use a combination of antennas, for example two dipoles as shown in FIG. 2, in order to get closer to uniform or non-directional volume radiation. In this case, the signals received by each antenna can be added to one another in order to obtain a greater output signal. A first drawback of such a system with several antennas resides in the fact that the power of the field received is not optimized when one of the signals received is noise. Furthermore, each signal received is regulated by a capacitor, which requires space on the integrated circuit. However, the very small size of such circuits means an extra cost when components are to be added to them.

### SUMMARY OF THE INVENTION

This is why the purpose of the invention is to provide an integrated circuit for a contactless radiofrequency device allowing the management of signals coming from several antennas in order to improve the radiation of the contactless device.

Another purpose of the invention is to provide a radiofrequency contactless device equipped with an integrated circuit allowing the management of signals coming from several antennas in order to improve the radiation.

The object of the invention is therefore an integrated circuit for a contactless radiofrequency device connected to a first antenna and to a second antenna designed to receive a radiofrequency signal coming from a reader. According to a main characteristic, the integrated circuit includes a first rectifier circuit and a second rectifier circuit to rectify each radiofrequency signal received from the first antenna and the second antenna, respectively, to produce two positive output voltages V1 and V2, the rectifier circuits being mounted in parallel in order to select an output voltage value that corresponds to the maximum voltage value between V1 and V2.

A second object of the invention is a contactless radiofrequency device equipped with an integrated circuit according to the first object.

### BRIEF DESCRIPTION OF THE DRAWINGS

The purposes, objects and characteristics of the invention will become more apparent from the following description when taken in conjunction with the accompanying drawings in which:

FIG. 1 represents a label equipped with a dipole type RFID antenna,

FIG. 2 represents a label equipped with two antennas,

FIG. 3 is a diagrammatic view of the communication between the RFID label and a reader,

FIG. 4 represents the circuit diagram of radiofrequency receiving systems of the integrated circuit according to the invention,

FIG. 5 represents the circuit diagram of radiofrequency receiving systems of the integrated circuit according to a specific example of the invention,

FIG. 6 represents the circuit diagram of radiofrequency receiving systems of the integrated circuit according to the invention,

FIG. 7 represents the circuit diagram of radiofrequency receiving systems of a specific example of the integrated circuit according to the invention,

FIG. 8 represents a first label according to a first embodiment of the invention,

FIG. 9 represents a second label according to the first embodiment of the invention,

FIG. 10 is a view of the label according to the invention positioned on two sides of a tridimensional object,

FIG. 11 is a view of the label according to the invention before being positioned on three sides of a tridimensional object according to a first method,

FIG. 12 is a view of the label according to the invention positioned on three sides of a tridimensional object according to a first method.

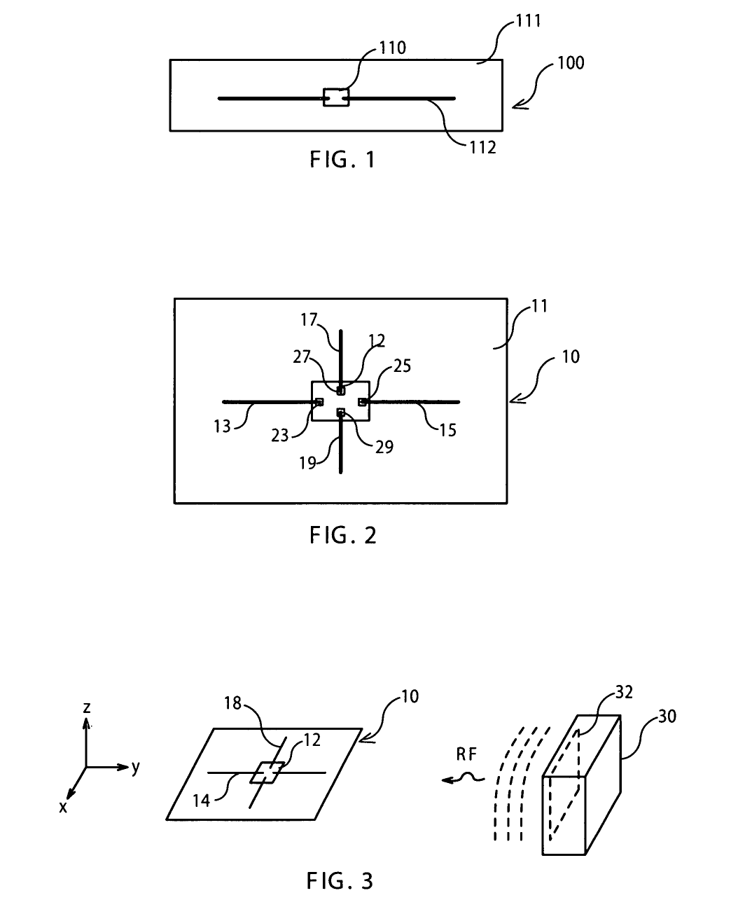

### DETAILED DESCRIPTION OF THE INVENTION

According to a preferred embodiment of the invention, the contactless radiofrequency device is a radiofrequency (RFID) identification label illustrated in FIGS. 2 and 3 made up of a support 10 on which is placed an integrated circuit 12 connected to two antennas 14 and 18. The support 11 is a support preferably made of a flexible material such as fibrous material like paper or synthetic material. Each antenna is a dipole type antenna made up of two wires. The first antenna 14 is made up of wires 13 and 15 and the second antenna 18 is made up of wires 17 and 19. The antennas 14 and 18 of the label 10 are printed on the support 11 by screen printing, flexography, rotogravure, offset printing or inkjet printing. The antenna is made with epoxy type conductive ink loaded with silver or gold particles or with a conductive polymer. The antennas 14 and 18 are preferably dipole antennas that have the dimension of approximately a half-wave length for the operating frequency. Each antenna is connected to the integrated circuit by means of contacts 23, 25, 27 and 29 of the chip, the wires 13 and 15 of the antenna 14 being connected to the contacts 23 and 25 of the integrated circuit and the wires 17 and 19 of the antenna 18 being connected to the contacts 27 and 29 of the integrated circuit. The contacts 23 and 25 of the integrated circuit are connected to a first receiving system whereas the contacts 27 and 29 are connected to a second receiving system. The integrated circuit features a memory zone containing, for example, the information required for the traceability of an object or for identifying a person, the information being readable by a reader by exchange of ultra high frequency (UHF) electromagnetic waves in the order of 1 GHz and in particular greater than 860 MHz (frequency of 1 GHz according to the ISO 18000-6 standard and frequency of 2.45 GHz according to the ISO 18000-4 standard).

During the exchange of information, power to the integrated circuit is supplied by electromagnetic waves transmitted by the reader. When the RFID label enters the field of a reader, a voltage is induced on each antenna. This UHF voltage is then processed in order to generate a positive and continuous voltage designed for supplying power to the circuit and a positive voltage having a suitable speed of variation to enable the demodulation of information transmitted by the reader. When the question is generating power for the circuit, we thus speak of rectifier whereas when the question is retrieving information modulated in amplitude, we speak of envelope detection. Since the processing of the first supply signal and the second signal corresponding to the modulated information are similar, we will thus describe in detail the processing of the signal intended for powering the circuit, considering that a similar description is applicable to the modulated signal representing the information. However, the differences will be mentioned. The peak value of the induced voltage in each antenna depends on the position of the antenna, thus on the orientation of the label with respect to the orientation of the reader's antenna. For example, in the case shown in FIG. 3, the label is positioned with respect to the Radiofrequency (RF) field emitted by the antenna 32 of the reader 30 in such a way that the voltage induced in the antenna 14 is less than the voltage induced in the antenna 18. Indeed, the radiation of a dipole antenna is very low along the antenna axis, that is to say in reference to FIG. 3 along the y axis, and is maximum in the plane perpendicular to the antenna, that is to say in the (x, z) plane and passing through its centre.

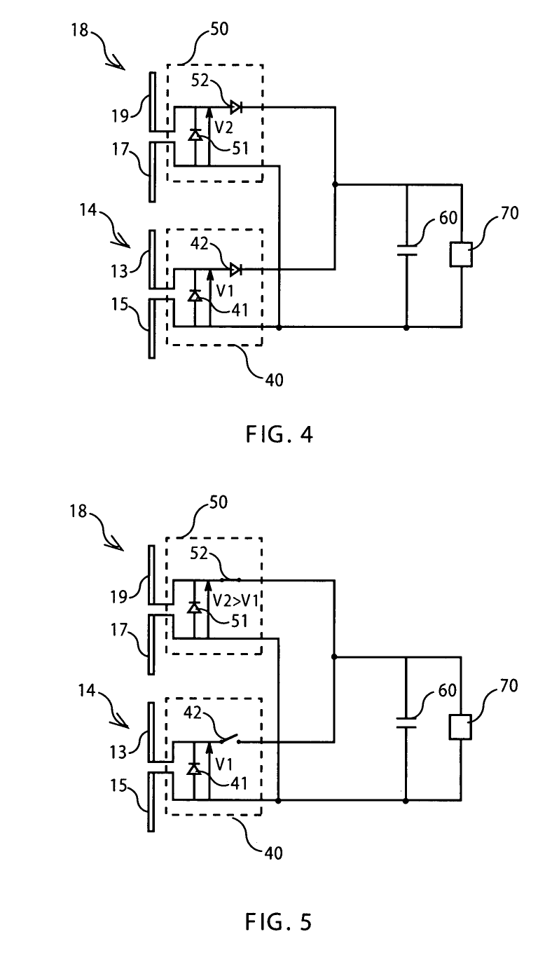

Through the contacts, each antenna is thus connected to a stage of the integrated circuit, and this corresponds to a radiofrequency receiver system. The integrated circuit connected to two antennas thus features two radiofrequency receiver systems. According to FIG. 4, the voltage induced by the antenna 14 is rectified by means of a rectifier circuit 40 featuring a first diode 41 and a second diode 42. Similarly, the voltage induced by the antenna 18 is rectified by means of a rectifier circuit 50 featuring a first diode 51 and a second diode 52. The rectifier circuits 40 and 50 can also use transistors installed as diodes or any other component ensuring the same function. The rectified output voltage of the antenna 14 is the positive and constant voltage V1 while the rectified output voltage of the antenna 18 is the voltage V2. The integrated circuit according to the invention enables to optimize the capacitor 60 required to regulate the output voltage applied to the terminals of the load 70 of the RFID label's integrated circuit, as the two rectifier circuits 40 and 50 are mounted in parallel so that the wires 15 and 17 of antennas 14 and 18 connected respectively to contacts 25 and 27 of the chip 12 are connected together by an ohmic connection. Indeed, in the case of an integrated circuit connected to two antennas according to prior art, each rectifier circuit requires a capacitor that can represent, in terms of surface, approximately two-thirds of the surface of the rectifier circuit. As a result, the integrated circuit according to the invention, although it contains two rectifier circuits, uses only one capacitor and saves surface area representing approximately two-thirds of the surface of a rectifier circuit.

Depending on the positioning of the RFID label with respect to the antenna of the reader, the values of V1 and V2 vary so that we always obtain 2 positive non-zero voltage values such as V1>V2 or V2>V1. Assuming that the output voltage V2 of the antenna 18 is greater than the output voltage V1 of the antenna 14, the current supplied by the voltage V2 and passing through the forward biased diode 52 can flow only through the load 70 insofar as the circuit passing through the diode 42 is open as the latter, in this case, is reverse biased (in the locked direction). With reference to FIG. 5, the diode 42 is therefore equivalent to an open switch resulting in the opening of the circuit passing through the diode 42.

Conversely, if V1>V2, the diode 52 will be reverse biased whereas the diode 42 will be forward biased. The current supplied by the voltage V1 will therefore not be able to flow through the diode 52 equivalent to an open switch, but only through the load 70.

The voltage induced in the antenna associated with the rectifier in which the diode is forward biased is thus the voltage that is applied to the load 70 in order to supply power to the circuit and exchange information coming from the reader. The integrated circuit according to the invention thus helps select the maximum voltage between the voltage V1 from the antenna 14 and voltage V2 from the antenna 18, which is therefore voltage V2 in the example described in FIG. 5. The maximum output voltage selected is then regulated by means of the capacitor 60 in order to power the load 70 of the integrated circuit of the RFID label 10. The voltage from the other antenna is not used in this case.

The voltages induced in each antenna generating the second signal corresponding to the modulated information are processed by two circuits known as envelope detectors, similar to the rectifier circuits 40 and 50. However, the envelope detector circuits have cut-off frequencies for the output signal greater than the cut-off frequencies of rectifier circuits designed to process the input signal. As a result, the output voltages V1 and V2 are not constant but vary at a speed adapted to the output of the modulated signal. For the signal corresponding to the modulated information, the integrated circuit according to the invention presents the advantage, when one of the voltages induced in one of the antennas is noise such as a parasite peak, of picking only the “good” signal. Whereas in the case of an integrated circuit that sums the induced voltages, the resulting signal will contain an interference that could cause a communication error.

The integrated circuit according to the invention for processing the input signal, as for processing the modulated information signal, has the advantage of saving space considering that it requires only one capacitor. Furthermore, even when one of the signals received by one of the antennas is noise, the integrated circuit according to the invention can process the modulated information signal without communication error so long as the amplitude of the noise remains lower than the amplitude of the signal received by the other antenna.

The antennas used can be of any type without deviating from the scope of the invention.

In addition, the label equipped with an integrated circuit according to the invention enables a positioning on any type of support such as pallet, cardboard box, without orientation constraints. The integrated circuit according to the invention can also be used for any contactless device.

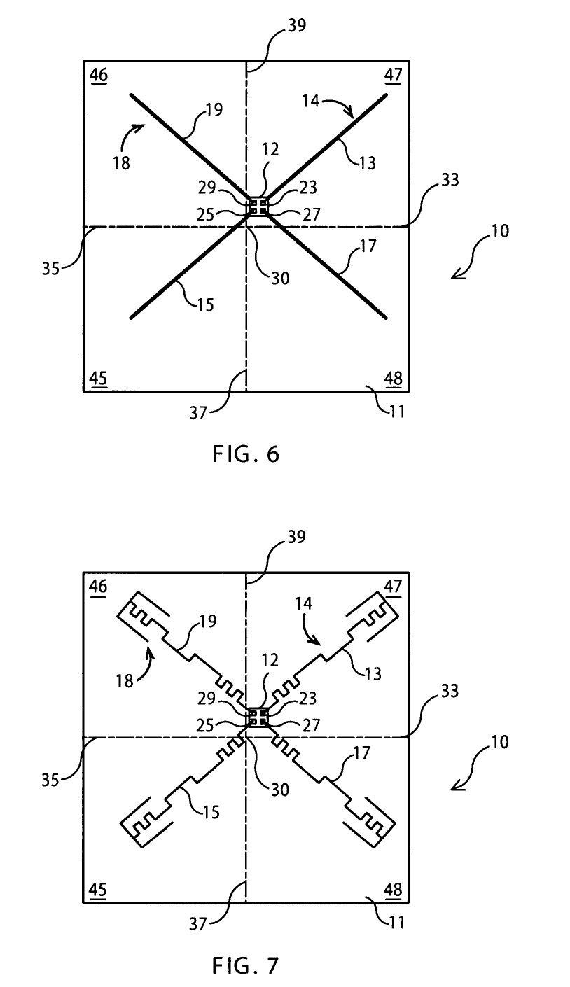

The integrated circuit according to the invention is particularly adapted to labels designed to be affixed on several sides of a tridimensional object such as a cardboard box. Such a label 10 is shown in FIG. 6 and features two axes 33-35 and 37-39 that cross each other at the point 30 located preferably at the centre of the label. The two axes 33-35 and 37-39 are preferably perpendicular to each other and are preferably axes of symmetry of the contactless label. The two axes 33-35 and 37-39 divide the contactless label into four zones 45, 46, 47, and 48. The wires 13, 15, 17, and 19 of the antennas are placed on the support 11 so that they do not overlap at the point of intersection 30 of the two axes 33-35 and 37-39 and they do not cross at least one of the semi-axes 33, 35, 37, or 39. According to our example shown, in this case it is the semi-axis 37 that is not crossed by any of the antenna wires. Furthermore, the integrated circuit 12 is placed so that it does not overlap one of the axes 33-35, 37-39. The axes 33-35 and 37-39 can be marked by colored lines on one of the sides of the label 10. The label also features a protective layer on the antenna support, used as a support for printing a logo or other items, and a layer of glue covered with a removable sheet of silicone treated paper.

FIG. 7 represents the same label with the same arrangement of antenna wires with respect to the axes as on the previous figure but with different antenna wires.

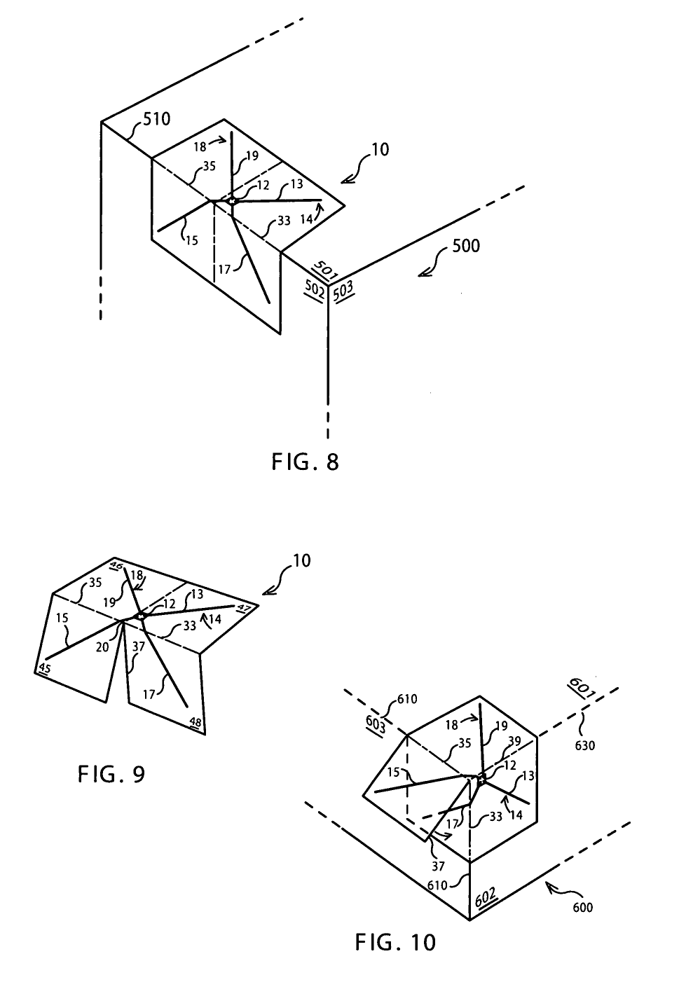

According to FIG. 8, the contactless label 10 is glued on the two sides of a tridimensional object such as a cardboard box 500. For this, the label may be preferably folded along the axis 33-35 so that the axis 33-35 is superimposed on the edge 510 of the cardboard box defining the two sides 501 and 502 thereof. The part of the label located on the side 501 of the cardboard box 500 consists of zones 46 and 47 that include the entire wire 13 of the antenna 14 and the entire wire 19 of the antenna 18 and a small portion of wires 15 and 17. The part of the label located on the second side 502 of the cardboard box 500 consists of zones 44 and 48 that include the major part of the wire 15 of the antenna 14 and the major part of the wire 17 of the antenna 18.

The contactless label 10 can also be affixed on three sides of a tridimensional object such as a cardboard box. In this case, the positioning of the label can be done in two ways, either a part of the label is removed, or a part of the label is covered. These two ways are illustrated in FIGS. 9 and 10 then 11 and 12 respectively.

According to FIG. 10, the contactless label 10 is cut along the semi-axis 37 till the point of intersection 30 and is preferably folded along the axis 33-35. The label 10 is then positioned on the cardboard box 600 so that the point of intersection 30 of the two axes of the label superimposes on the corner of the cardboard box 600 while the semi-axis 35 superimposes on the edge 610 of the cardboard box 600 and the semi-axis 39 superimposes on the edge 630 of the cardboard box as shown in FIG. 10. The part 46 of the label located on the side 601 of the box 600 includes the major part of the wire 19 of the antenna 14 and a small part of the wire 15 of the antenna 14. The part 47 of the label located on the second side 602 of the cardboard box 600 includes the entire wire 13 of the antenna 14 and a small part of the wires 15, 17 and 19 as well as the integrated circuit 12. The part 45 of the label located on the third side 603 of the cardboard box 600 covers the part 48 of the label 10. In this manner, the part of the label located on the third side includes a major part of the wire 15 of the antenna 14 and the major part of the wire 17 of the antenna 18.

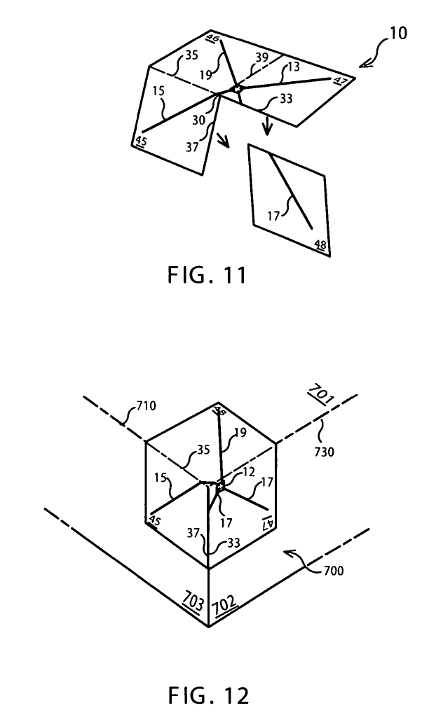

To place the contactless label on the three sides of a tridimensional object such as a cardboard box, a part of the label can also be removed. In this case, according to FIG. 11, the label is cut along the semi-axes 33 and 37 till the point of intersection 30 and the zone 48 is detached from the label 10. In this manner, the major part of the wire 17 of the antenna 18 is removed. The wires 15 and 17 being connected together, the wire 15 is used as a second wire for antenna 14 as well as antenna 18.

The label 10 is then positioned on the cardboard box 700 so that the point of intersection 30 of the two axes of the label superimposes on the corner of the cardboard box 700 while the semi-axis 35 superimposes on the edge 710 of the cardboard box 700 and the semi-axis 39 superimposes on the edge 730 of the cardboard box as shown in FIG. 12. The part 46 of the label located on the side 701 of the cardboard box 700 includes the major part of the wire 19 of the antenna 14 and a small part of the wire 15 of the antenna 14. The part of the label located on the second side 702 of the cardboard box 700 consists of the zone 47 and includes the entire wire 13 of the antenna 14 and a small part of the wires 15, 17, and 19 as well as the integrated circuit 12. The part of the label located on the third side 703 of the cardboard box 700 consists of the zone 45 and includes the major part of the wire 15 of the antenna 14. The two wires 15 and 17 of the respective antennas 14 and 18 being connected together, the antenna 14 consists of wires 13 and 15 and the antenna 18 consists of wires 19 and 15. Depending on the incidence of the field emitted by the reader, it is the antenna 14 consisting of wires 13 and 15 or the antenna 18 consisting of wires 19 and 15 that power the integrated circuit 12.

Generally, the two axes 33-35 and 37-39 are used as axis along which the label can be folded, and the semi-axis 37 can be cut without disturbing the operation of the label. In order to make it easier to install the label on the two sides or the three sides of a tridimensional object such as a cardboard box, the semi-axes 33, 35, 37, and 39 which are either fold axes, or cut-out axes, may be preformed, that is to say the label may be folded beforehand along the axes during fabrication.

When the label according to the invention is placed on two or three sides of a tridimensional object, the reader exchanges data with at least one of the two antennas. Indeed, whether one of the two antennas is masked or not, one of the two will transmit special radiation with respect to the other with regard to the reader and it is this one that will power the integrated circuit, given that only the maximum voltage amongst the two voltages of the input signals of the antennas is selected. Thus, according to the incidence of the field emitted by the reader, the integrated circuit is powered by the antenna 14 or by the antenna 18.

1. Circuit intégré (12) pour dispositif sans contact radiofréquence connecté à une première antenne (14) et à une seconde antenne (18) étant destinées à recevoir un signal radiofréquence en provenance d'un lecteur,
caractérisé en ce que ledit circuit intégré (12) comprend un premier circuit redresseur (40) et un second circuit redresseur (50) pour redresser chaque signal radiofréquence recu respectivement de ladite première antenne (14) et de ladite seconde antenne (18), de facon à produire deux tensions de sortie positives V1 et V2, lesdits circuits redresseur (40 et 50) étant montés en parallèle de facon à sélectionner une valeur de tension de sortie qui correspond à la valeur de tension maximale entre V1 et V2.

2-12. (canceled)
